(19) United States
(12) Patent Application Publication
(10) Pub. No.: US 2010/0156611 A1
(43) Pub. Date: Jun. 24, 2010

(54) APPARATUS FOR COMMUNICATING WITH RFID TAG

(75) Inventors: Yoshiyuki TSUJIMOTO, Aichi-ken (JP); Yasuhisa Ichikawa, Aichi-ken (JP); Takuya Nagai, Aichi-ken (JP)

Correspondence Address: DAY PITNEY LLP, 7 TIMES SQUARE, NEW YORK, NY, 10036-7311, US

(73) Assignee: Brother Kogyo Kabushiki Kaisha, Aichi (JP)

(21) Appl. No.: 12/635,934

(22) Filed: Dec. 11, 2009

(30) Foreign Application Priority Data
Dec. 24, 2008 (JP) 2008-327147

(51) Int. Cl. H04Q 5/22

(52) U.S. Cl. 340/10.42

(57) ABSTRACT

This disclosure discloses an apparatus for communicating with an RFID tag comprising: an apparatus antenna device configured to conduct radio communication with an RFID tag circuit element; a tag information obtainment portion configured to obtain identification information from the RFID tag circuit element via the apparatus antenna device; a management item determination portion configured to determine, when the tag information obtainment portion obtains the identification information, whether or not there is an unregistered management item for which management data is not registered in a database configured to store the obtained identification information and management data for a management item of a target article to which the RFID label is affixed in association with each other; and an unregistered information display device configured to display, when the management item determination portion determines that there is an unregistered management item, information relating to the unregistered management item.

### CROSS-REFERENCE TO RELATED APPLICATION

The present application claims priority from Japanese Patent Application No. 2008-327147, which was filed on Dec. 24, 2008, the disclosure of which is incorporated herein by reference in its entirety.

### BACKGROUND OF THE INVENTION

1. Field of the Invention

The present invention relates to an apparatus for communicating with an RFID tag configured to conduct radio communication with an RFID tag.

2. Description of the Related Art

There has been known a Radio Frequency Identification (hereinafter referred to as an RFID) system configured to read and write information contactlessly between a small-sized RFID tag and an apparatus for communicating with an RFID tag. The RFID tag is provided with an RFID tag circuit element. The RFID tag circuit element includes an IC circuit part storing predetermined information and a tag antenna connected to the IC circuit part for performing information transmission and reception.

This RFID system has been put into practice in various fields. The RFID system is used in various works in businesses of sales, distribution, for example. Examples of the works include inventory carried out regularly to check a stock of goods, search of a lost article, check of a component, and goods entering and dispatching from warehouse. In such a work scene, an operator reads information using a handheld apparatus for communicating with an RFID tag from the RFID tag circuit element installed in a target article to be managed in general. By means of this information reading, article management, for example, is performed.

For example, in a management system of the prior art reference, if articles of plural owners are mixed in a limited area, location information of the RFID tag attached to the article is acquired. The acquired location information is associated with identification information of the RFID tag and registered in a database.

However, in such article management, there are usually a wide variety of management items for a single article. A work to register management data for such plural management items in a database at once requires extremely many work processes and is a complicated work. Also, in a management situation for an article, if entry is missed for a particularly required item, information shortage occurs for the article, and management of the article becomes difficult. Moreover, if a management item is newly added, the management data needs to be updated and registered for all the articles accordingly, and a work for registration, while searching and checking presence of registration of the management data for each article, becomes a much more complicated work requiring a large quantity of labor.

### SUMMARY OF THE INVENTION

The present invention was made in order to solve the above problems. An object of the present invention is, when an articles is managed, for example, to provide an apparatus for communicating with an RFID tag that can display information relating to unregistered management items for which management data has not been registered among the management items for the article when the apparatus for communicating with an RFID tag obtains identification information of an RFID tag circuit element provided in an article in inventory taking, for example.

### BRIEF DESCRIPTION OF THE DRAWING

FIG. 1 is an appearance diagram illustrating an entire appearance of an apparatus for communicating with an RFID tag of this embodiment.

FIG. 2 is a functional block diagram illustrating a functional configuration of an apparatus for communicating with an RFID tag.

FIG. 3 is a table illustrating an example of stored contents of a database.

FIG. 4 is an appearance diagram of an RFID label provided with an RFID tag circuit element.

FIG. 5 is a functional block diagram illustrating an example of a functional configuration of an RFID tag circuit element disposed in the RFID tag.

FIG. 6 is a flowchart illustrating a control procedure executed by a control circuit of an apparatus for communicating with an RFID tag.

FIG. 7 is a flowchart illustrating a control procedure executed by a control circuit of an apparatus for communicating with an RFID tag.

FIG. 8 is a diagram illustrating an example of a display screen displayed on a display.

FIG. 9 is a diagram illustrating another example of a display screen displayed on a display.

FIG. 10 is a flowchart illustrating a control procedure of another example executed by a control circuit of an apparatus for communicating with an RFID tag.

FIG. 11 is a table illustrating another example of stored contents of a database.

FIG. 12 is a diagram illustrating another example of a display screen displayed on a display.

FIG. 13 is a flowchart illustrating a control procedure of a variation executed by a control circuit of an apparatus for communicating with an RFID tag.

FIG. 14 is a flowchart illustrating a control procedure of a variation executed by a control circuit of an apparatus for communicating with an RFID tag.

FIG. 15 is a flowchart illustrating a control procedure of a variation executed by a control circuit of an apparatus for communicating with an RFID tag.

### DETAILED DESCRIPTION OF THE PREFERRED EMBODIMENTS

An embodiment of the present invention will be described below referring to the attached drawings.

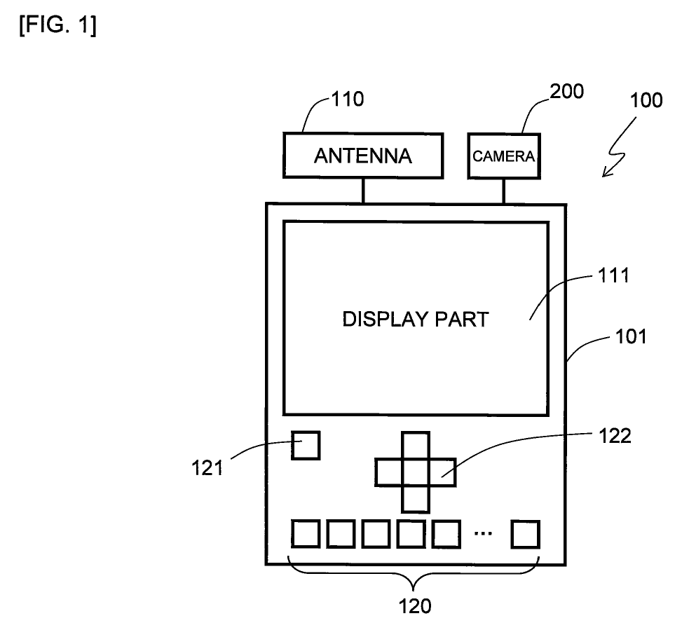

In FIG. 1, an apparatus 100 for communicating with an RFID tag has a substantially rectangular solid housing 101 and an opening-and-closing cover, not shown, disposed capable of being opened and closed with respect to the housing 101.

On an upper part of the housing 101, a communication antenna 110 as an apparatus antenna device configured to perform information transmission and reception with an RFID tag circuit element To, which will be described later, and a camera 200 as imaging device capable of imaging an article. Also, on the housing 101, a display part 111 is disposed as an unregistered information display device configured to make various kinds of display. The display part 111 includes a display such as a liquid crystal panel. Moreover, below the display part 111, an operation input part 120 including a plurality of operation buttons and operation keys is disposed. The operation input part 120 includes a start key configured to start radio communication with the RFID tag circuit element To, a stop key configured to stop the radio communication, and numeral keys, for example. Also, on the housing 101, a power source button 121 configured to turn ON or OFF a power source of the apparatus 100 and an operation input key 122 are disposed. The operation input key 122 includes four-way keys arranged substantially in a cross shape and a determination key arranged at the center of the four-way keys. Instead of the operation input part 120 and the operation input key 122, operation information may be entered using a touch panel displayed on the display part 111.

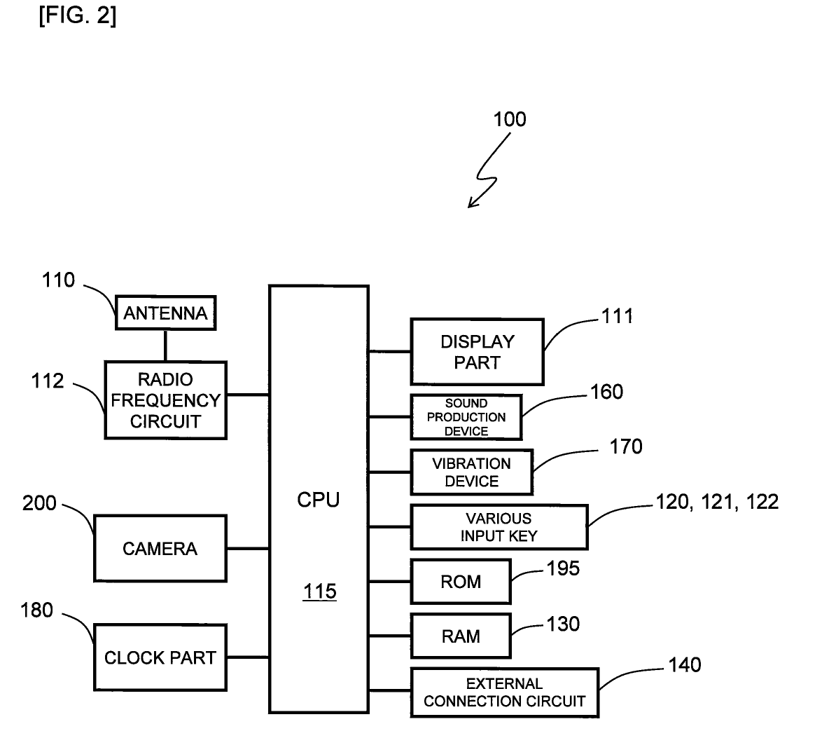

As shown in FIG. 2, the apparatus 100 has a control circuit 115, a RAM 130 connected to the control circuit 115, a ROM 195, an external connection circuit 140, a sound production device 160, and a vibration device 170. The control circuit 115 is a CPU that controls the entire apparatus 100 including the display part 111, a radio frequency circuit 112, and a clock part 180, for example. Also, the apparatus 100 has the communication antenna 110, the display part 111, the radio frequency circuit 112, the camera 200 configured to acquire image information, and various input keys. The radio frequency circuit 112 accesses the RFID tag circuit element To of an RFID tag T through the communication antenna 110 via radio communication and also processes a signal read from the RFID tag circuit element To. The various input keys include the operation input part 120, a power source button 121, the operation input key 122, for example. A database 131, which will be described later, in this embodiment is stored in the RAM 130.

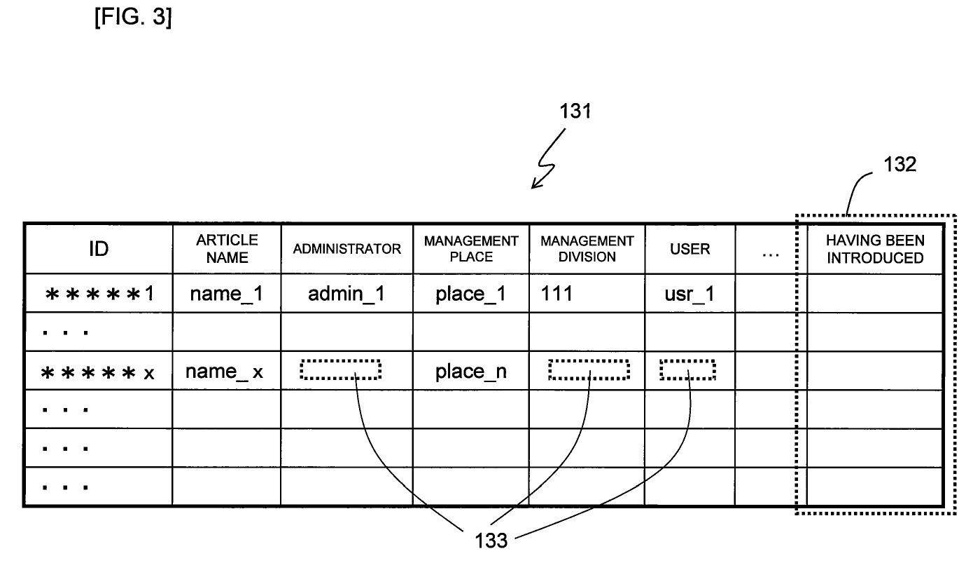

In FIG. 3, in the database 131, management data for various management items are registered in association with identification information, which is a tag ID of the RFID tag circuit element disposed at an article to be managed. The management items include, for example, “article name”, “administrator”, “management place”, “date of purchase”, and “user” of a target article. In FIG. 3, for example, for an ID “*****1”, which is identification information, “name_{—}1” is stored as management data for the management item “article name”, and “admin_{—}1” is stored as management data for the management item “administrator”.

On the other hand, there is no need to register all the management items and the management data for them from the first place. That is, it is only necessary that a user enters minimum required management data when an operator is to start management of an article. In FIG. 3, “name_x” is registered as management data for the management item “article name” for the ID “*****x”, which is the identification information. The management items “administrator”, “management division”, and “user”, however, have no management data but remain as unregistered columns 133. Incidentally, the above management items can be changed according to an operation situation, an added column 132 of the management item is created, the management item is updated, or the management item is deleted arbitrarily as necessary.

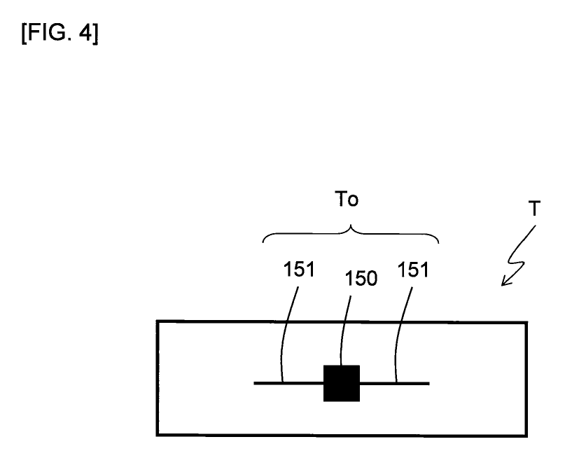

In FIG. 4, the RFID tag circuit element To is disposed on the label-shaped RFID label T. By providing the RFID label T on a target article, identification information of the RFID tag circuit element To is associated with the article. In an IC circuit part 150 of the RFID tag circuit element To, a tag ID for identifying the target article is stored.

The tag ID stored in the RFID tag circuit element To is recorded in the database 131 in association with the management item and the management data for managing the respective articles. The apparatus 100 can access the database 131 on the basis of the tag ID read from the RFID tag circuit element To via radio communication.

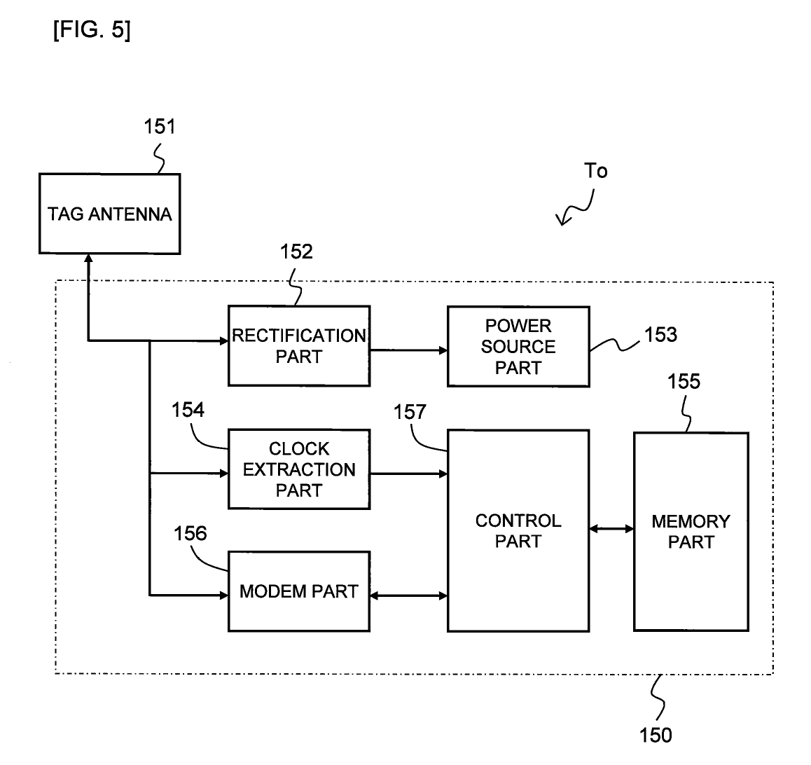

In FIG. 5, the RFID tag circuit element To has a tag antenna 151 and the IC circuit part 150.

The IC circuit part 150 includes a rectification part 152, a power source part 153, a clock extraction part 154, a memory part 155, a modem part 156, and a control part 157. The rectification part 152 rectifies an interrogation wave received by the tag antenna 151. The power source part 153 accumulates energy of the interrogation wave rectified by the rectification part 152 and uses the energy as a driving power source of the RFID tag circuit element To. The clock extraction part 154 extracts a clock signal from the interrogation wave received by the tag antenna 151 and supplies the signal to the control part 157. The memory part 155 stores a predetermined information signal. The control part 157 controls operations of the RFID tag circuit element To through the memory part 155, the clock extraction part 154, a random number generator 158, and the modem part 156, for example.

The modem part 156 demodulates an interrogation wave from the communication antenna 110 of the apparatus 100, received by the tag antenna 151. The modem part 156 also modulates a reply signal from the control part 157 and transmits it as a response wave, that is, a signal including the tag ID, from the tag antenna 151.

The control part 157 interprets a received signal demodulated by the modem part 156 and generates a reply signal on the basis of the information signal stored in the memory part 155. Then, the modem part 156 transmits the reply signal through the tag antenna 151.

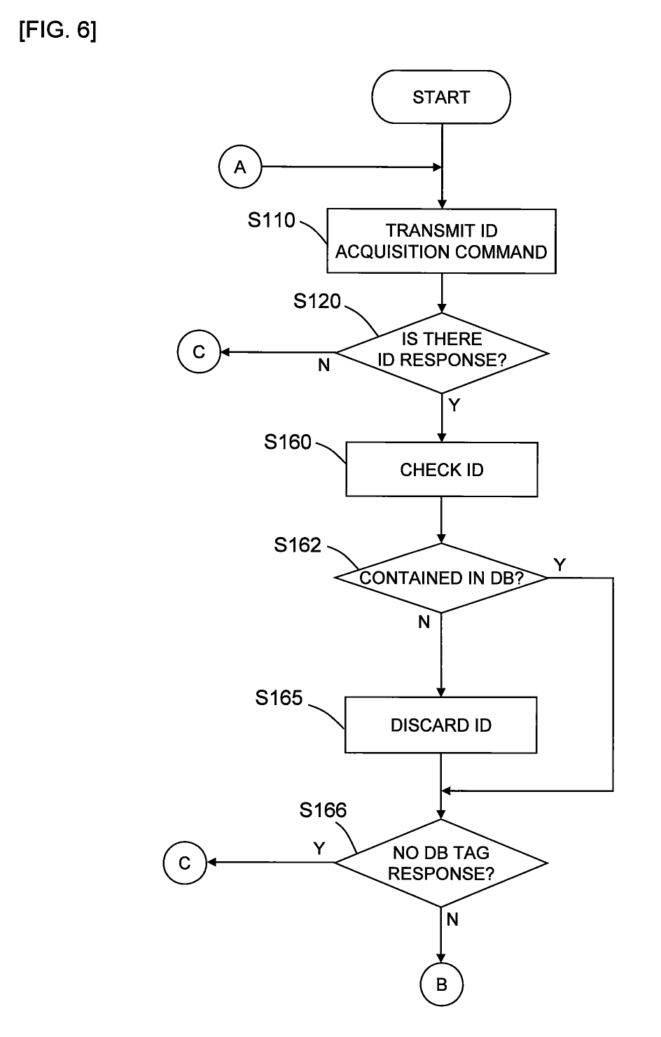

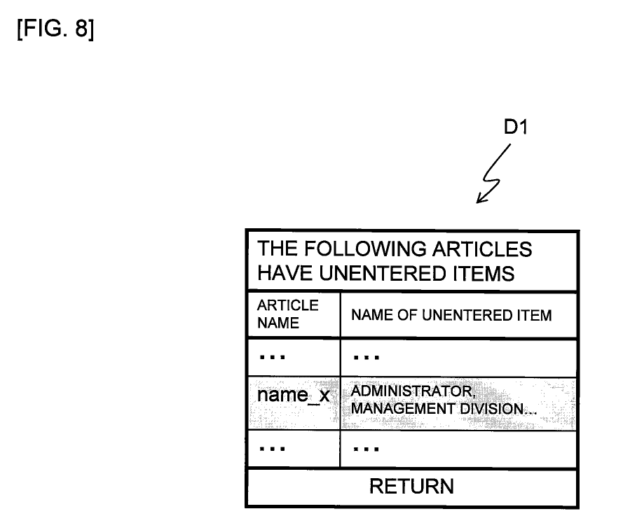

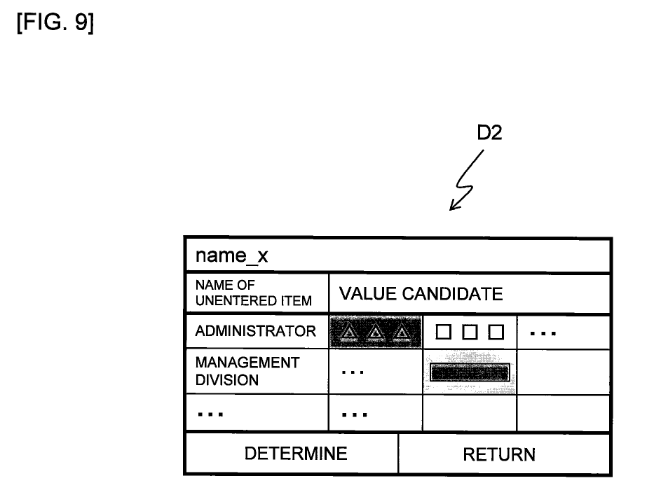

Subsequently, an operation of the apparatus 100 will be described referring to FIGS. 6 to 9. FIGS. 8 and 9 show examples of a display screen displayed on the display part 111 in this embodiment on the basis of the database in FIG. 3, as will be described later.

First, the control circuit 115 starts a flowchart in FIG. 6 when a start operation to start tag reading is performed by an operator.

At Step S110, the control circuit 115 outputs a control signal to the radio frequency circuit 112. The radio frequency circuit 112 transmits an interrogation wave as an ID acquisition command which has been applied with predetermined modulation to all the tags present in a communication range through the communication antenna 110. The ID acquisition command is a tag reading signal to read data recorded in the memory part 155 of the RFID tag circuit element To. After that, the routine goes to Step S120.

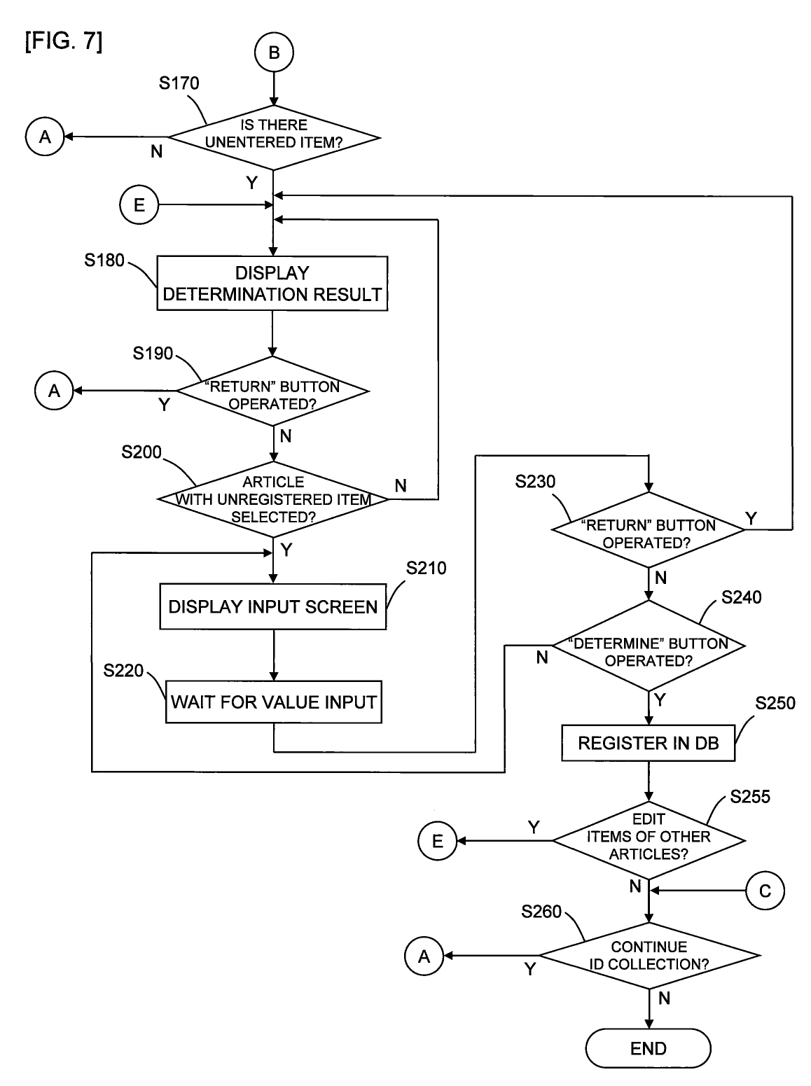

At Step S120, the control circuit 115 determines if a reply signal from the tag for the tag reading signal has been received or not through the communication antenna 110 and the radio frequency circuit 112. If it is determined that the reply signal has been received, the determination is satisfied, and the routine goes to Step S160. On the other hand, if the reply signal has not been received, the determination is not satisfied, and the routine goes to Step S260 in FIG. 7. At Step S260, the control circuit 115 determines if a processing end operation has been performed by the operator or not on the basis of an operation input signal from the stop key.

At Step 160, the control circuit 115 accesses the database 131 stored in the RAM 130 and checks the acquired tag ID with the tag ID registered in the database 131. After that, the routine goes to Step S162.

At Step S162, the control circuit 115 determines if the tag ID is the one registered in the database 131 as the result of the check at Step S160. If it is the tag ID registered in the database, the determination at Step S162 is satisfied, and the routine goes to Step S166, which will be described later. If it is not the tag ID registered in the database, the determination at Step S162 is not satisfied, and the routine goes to Step S165. At Step S165, the control circuit 115 discards the tag ID acquired at step S120. After that, the routine goes to Step S166.

At Step S166, it is determined whether or not there has been no response at all from the tag whose tag ID is registered in the database 131. If there has been a response from the tag whose tag ID is registered in the database 131, the determination at Step S166 is not satisfied, and the routine goes to Step S170 of FIG. 7. On the other hand, if there is no response from the tag whose tag ID is registered in the database 131, the determination at Step S166 is satisfied, and the routine goes to Step S260 in FIG. 7, which will be described later.

Subsequently, at Step S170 in a flowchart in FIG. 7, it is determined whether or not corresponding management data is registered in each of all the management items for the tag ID checked at Step S160. If the management data is registered for all the management items, the determination at Step S170 is not satisfied, and the routine returns to Step S110 in FIG. 6. On the other hand, if there is an item for which the management data is not registered in the management items, that is, if there is an unregistered management item, the determination at Step S170 is satisfied, and the routine goes to Step S180 in FIG. 7. For example, all the management data is registered for each of the management items for the tag ID “*****1” in the example in the database 131 shown in FIG. 3. Therefore, in this case, the determination at Step S170 is not satisfied, and the routine goes to Step S110 in FIG. 6. On the other hand, in the case of the tag ID “*****x” in FIG. 3, the management data is not registered in each of the management items “administrator”, “management division”, and “user”. Therefore, the determination at Step S170 is satisfied, and the routine goes to Step S180.

At Step S180, the control circuit 115 outputs a control signal to the display part 111, which displays information relating to the unregistered items for the tag ID as a determination result at Step S170. In the example of the database 131 shown in FIG. 3, the management items of the article name “name_x” associated with the tag ID “*****x” include the unregistered management item. In this case, as in a display screen D1 in FIG. 8, character information to promote awareness of the operator that “The following articles have unentered items” is displayed. Also, below the character information, the article name “name_x” associated with the tag ID and “administrator, management division . . . ”, for example, as unentered items, that is, unregistered management items, are displayed. Only information relating to presence of the unregistered management item such as “There is an unregistered management item” may be displayed without specific display of the unregistered management items.

Returning to FIG. 7, after that, at Step S190, the control circuit 115 determines if an operation signal to operate a “return” button on the display screen D1 displayed on the display part 111 has been inputted by the operator by using the operation input key 122, for example. If the “return” button has been operated, the determination at Step S190 is satisfied, the display screen D1 of the determination result is closed, and the routine returns to Step S110. On the other hand, if the “return” button has not been operated, the determination at Step S190 is not satisfied, and the routine goes to Step S200.

At Step S200, the control circuit 115 determines if an article name having an unregistered management item has been selected or not in the display screen displaying the determination result. If a specific article name having the unregistered management item has been selected, as shown in the example of the display screen D1 in FIG. 8, the column of the article name “name_x” selected by the operation input key 122 is displayed in a different mode such as in a color different from the other portions. Then, the determination at Step S200 is satisfied by this selection, and the routine goes to the subsequent Step S210. On the other hand, if a specific article name having an unregistered management item has not been selected, the routine returns to Step S180, and the determination result is displayed till the “return” button is operated at Step S190.

At Step S210, the control circuit 115 displays a screen to enter the management data so that the management data can be entered for the unregistered management item for the article name selected at Step S200. After that, at Step S220, the control circuit 115 stands by for a predetermined time till the operator enters the management data during the display. FIG. 9 is an example of an input screen D2 to enter the management data for an unentered item of the article name “name_x” selected at Step S200. As shown in FIG. 9, for the unentered item “administrator”, candidates envisaged and registered in advance as value candidates of input information are displayed as “XXX” and “YYY”, for example.

The operator selects a value to be entered as the administrator by the operation input key 122 from the value candidates shown in FIG. 9. If there is no information to be entered in the displayed value candidates, the operator operates the operation input part 120 or the operation input key 122 so as to move to an information input screen. This information input screen is a screen in which the operator manually registers management data. In FIG. 9, it is set such that the routine goes to the information input screen by selecting a column for the unentered item “management division” immediately below “YYY” displayed in a mode different from the specific candidates as the “XXX” and “YYY”.

Returning to FIG. 7, if the stand-by at Step S220 is finished, the control circuit 115 goes to the subsequent Step S230. At Step S230, it is determined if the operator has operated the “return” button by the operation input key 122, for example, in the input screen D2. If the “return” button has been operated, the determination at Step S230 is satisfied, the input screen D2 is closed, the routine returns to Step S180, and the display screen D1 of the determination result is displayed (See FIG. 8). On the other hand, if the “return” button has not been operated, the determination at Step S230 is not satisfied, and the routine goes to Step S240.

At Step S240, the control circuit 115 determines if a “determine” button has been operated by the operation input part 120 or the operation input key 122, for example, in response to the selection of the management data by the operator from the value candidates in the input screen D2 in FIG. 9 or input of the management data by the manual operation. If the “determine” button has not been operated, the determination at Step S240 is not satisfied, the routine returns to Step S210, and the subsequent processing is executed. On the other hand, if the “determine” button has been operated, the determination at Step S240 is satisfied, and the routine goes to Step S250. At Step S250, the control circuit 115 registers the candidate value selected in the input screen D2 or the manually entered value as above in the database 131 corresponding to the management items associated with the tag ID. Then, the routine goes to Step S255.

At Step S255, the control circuit 115 determines if the management items of the other articles will be continuously edited or not. If the “determine” button for determining to edit the management items of the other articles is operated, the determination at Step S255 is satisfied, and the routine returns to Step S180. On the other hand, if edition of the management items of the other articles has not been particularly determined, the determination at Step S255 is not satisfied, and the routine goes to Step S260.

Subsequently, at Step S260, the control circuit 115 determines if the operator has operated the “return” button to continue reading of the tag ID by the operation input key 122, for example. If the “return” button has been operated, the determination at Step S260 is satisfied, the routine returns to Step S110, and the ID acquisition is continued. On the other hand, if the “return” button has not been operated but an end key in the operation input part 120 has been pressed to perform an end operation, the determination at Step S260 is not satisfied, and processing of this flow is finished.

In the above, the communication antenna 110 of the apparatus 100 is the apparatus antenna device to conduct radio communication with the RFID tag circuit element To, which is disposed on the RFID label T and includes the IC circuit part 150 that can store information and the tag antenna 151 capable of information transmission and reception. Also, at Step S110 executed by the control circuit 115, the processing to acquire identification information from the RFID tag circuit element To through the apparatus antenna device 110 corresponds to a tag information obtainment portion. At Step S170 executed by the control circuit 115, the processing to determine whether or not there is an unregistered management item for which the management data is not registered, in the database 131, constitutes an unregistered management item determination portion. The database 131, when the tag information obtainment portion obtains the identification information, stores the identification information of the RFID tag circuit element To and the management data corresponding to the management item of the target article to which the RFID label T is affixed, in association with each other. Moreover, if the management item determination portion determines that there is an unregistered management item, the display part 111 configured to display information relating to the unregistered management item constitutes an unregistered information display device. Also, the operation input part 120 and the operation input key 122, for example, which can enter the management data corresponding to the unregistered management item, are input devices. Also, at Step S250 executed by the control circuit 115, the processing to register the candidate values and manually entered values as the management data entered by the input devices in the database 131 corresponding to the management item associated with the tag ID constitutes a management data registration portion.

As described above, in the apparatus for communicating with an RFID tag of this embodiment, when the RFID tag ID is acquired, it is checked with the database. If there is an unregistered item in the management items associated with the RFID tag ID, display relating to the unregistered management item is made on the display part. Therefore, the operator can grasp that there is an unregistered management item reliably and easily without searching the database in order to enter the management data. Particularly, even if a change is made such as addition of the management item according to an operation situation, the operator can reliably grasp presence of the unregistered management item when the apparatus for communicating with an RFID tag acquires the tag ID. Therefore, the operator does not have to carry out a work such as search and examination of the database again. Also, at that time, if the management data is displayed capable of input by selection of an article name having the unregistered management item, for example, the operator can enter the management data on the spot. With the arrangement, workability for the operator is improved. As a result, a probability of missing entry of the management data for the management item can be further reduced.

In this embodiment, there can be various variations in a range not departing from its gist and technical idea other than the above. For example, the display part 111 may only display if there is an unregistered management item in which information has not been entered in the management items associated with the acquired tag IDs. That is, the display part 111 displays only the display screen D1 in FIG. 8, for example, and does not display the input screen D2 in FIG. 9. In this case, if the “return” button is not operated at Step S190 in the flowchart in FIG. 7, the routine goes to Step S260, the routine stands by till the end key of the operation input part 120 is operated, and if the end key is operated, this flow is finished. On the other hand, if the “return” button is operated, the routine returns from Step S190 to Step S110 in FIG. 6. As a result, during an operation such as inventory taking, the operator can easily grasp that there is an unregistered management item in the management items for the article associated with the acquired tag ID. Therefore, there is no need to carry out separate search to see if there is an item for which information has not been entered. Then, the management data can be entered by accessing the database 131 as necessary.

(1) When unregistered management items for a plurality of tag IDs are displayed in a list:

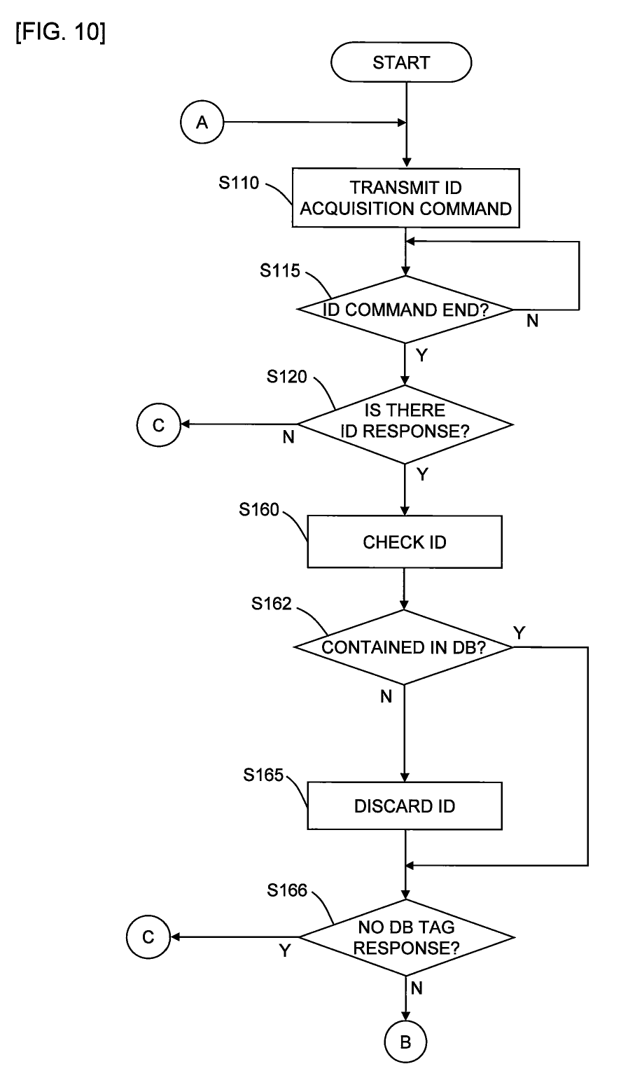

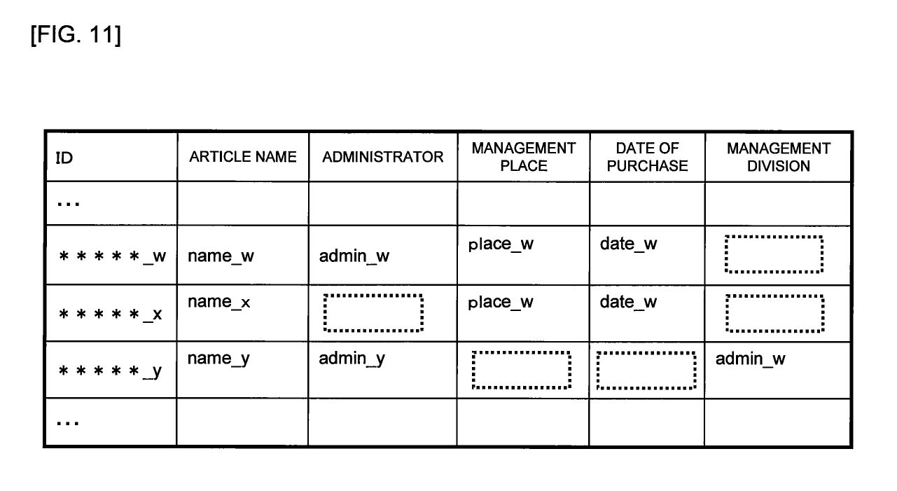

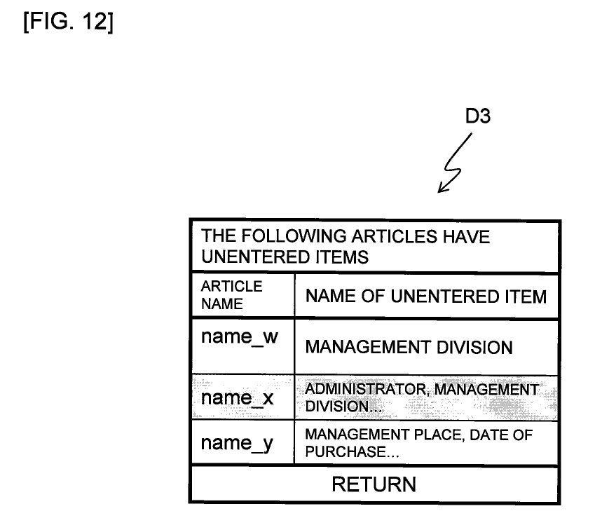

This variation will be described using FIGS. 10 to 12. FIG. 10 is a flowchart corresponding to FIG. 6. The same reference numerals are given to the procedures equivalent to those in FIGS. 6 and 7, and the description will be omitted. Also, FIG. 12 shows an example of a listed display screen D3 displayed on the display part 111 in this variation on the basis of a database in FIG. 11.

In FIG. 10, in this variation, Step S115 is provided after Step S110. At Step S115, the control circuit 115 determines if single transmission of the ID acquisition command has been completed or not. If the single transmission of the ID acquisition command has not been completed, the determination at Step S115 is not satisfied, and the determination at Step S115 is repeated, while if the single transmission of the ID acquisition command has been completed, the determination at Step S115 is satisfied, and the routine goes to Step S120 and after.

Also, in this variation, at Step S170 in FIG. 7, the control circuit 115 determines if the corresponding management data is registered or not for each of the management items for each of the plurality of tag IDs. If the management data is registered for all the management items associated with the plurality of tag IDs, the determination at Step S170 is not satisfied, and the routine returns to Step S110 in FIG. 10. On the other hand, if any of the plurality of tag IDs has an unregistered management item for which management data is not registered, the determination at Step S170 is satisfied, and the routine goes to Step S180.

At Step S180, the control circuit 115 outputs a control signal to the display part 111, which displays information relating to the unregistered item for the tag ID in a list as a determination result at Step S170. Subsequently, processing at Step S190 and after is executed.

An example of database contents used in this variation is shown in FIG. 11. As in this example, if there is an unregistered item in the management items associated with the tag ID, the result display screen D3 as shown in FIG. 12 is displayed. On this result display screen D3, unregistered management items for the plurality of article names “name_w”, “name_x”, and “name_y” are displayed in a list. This display screen needs not to be displayed on one screen, and if there are a large number of target articles, the screen may be scrolled or displayed capable of transition to the subsequent pages.

As described above, in this variation, the article names associated with the plurality of tag IDs and information relating to the corresponding unregisrered management items are displayed. As a result, unregistered management items for the plurality of articles can be easily grasped in a lump sum, and convenience for the operator is improved.

(2) When a predetermined management item is to be set:

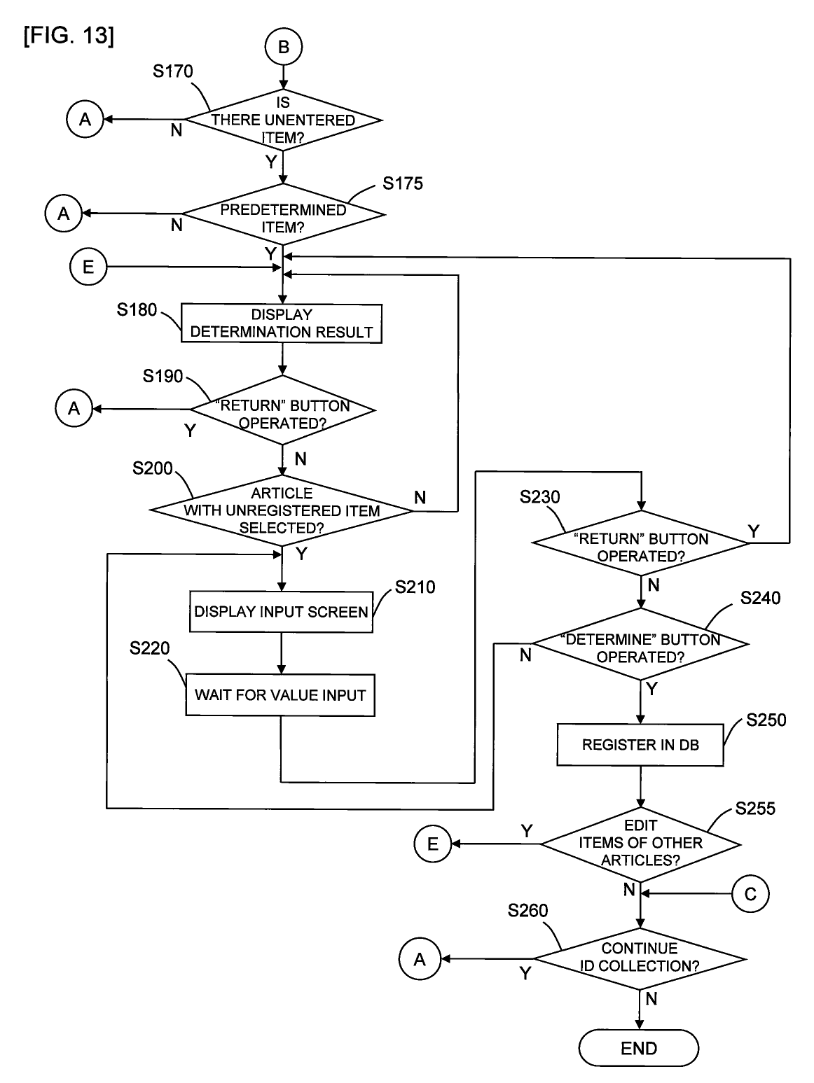

This variation will be described using FIG. 13. FIG. 13 is a flowchart corresponding to FIG. 7. The same reference numerals are given to the procedures equivalent to those in FIGS. 6 and 7, and the description will be omitted.

In FIG. 13, in this variation, Step S175 is added after Step S170. At Step S175, if there is an unregistered management item and the determination is satisfied at Step S170, the control circuit 115 determines if the unregistered management item is a predetermined unregistered management item or not. The predetermined management item is an item set in advance in which the management data should be registered in the database. That is, in the database 131, a flag indicating the predetermined management item is set in advance for the applicable management item. If it is determined that the item is the predetermined unregistered management item at Step 175, the routine continues to processing at Step S180 and after. On the other hand, if it is determined that the item is not the predetermined unregistered management item, the routine returns to Step S110 and executes tag ID acquisition.

In the above, at Step S175 in FIG. 13 executed by the control circuit 115 of the apparatus 100, processing to determine whether or not the unregistered management item is the predetermined management item for which the management data should be registered when the management item determination portion determines that there is an unregistered management item in the management items associated with the tag ID, constitutes an unregistered management item determination portion. By displaying the predetermined unregistered management item determined as the item for which the management data should be registered as above, the operator can efficiently grasp that the management item requiring registration has not registered yet. Particularly, this is effective if an auxiliary management item for which the management data does not have to be registered actually is included in a large number of management items set in a wide variety. In the above, at Step S175, a flag is set in the database 131 as the predetermined management item, and determination is made based on the flag. However, not limited to this method, determination on whether or not to make display on the display part may be made for each management item for each application.

(3) When a predetermined management item is determined on the basis of related information;

In this variation, description will be made using the flowcharts in FIGS. 6 and 13 similarly to the above (2). FIG. 13 is, as described above, a flowchart corresponding to FIG. 7, and the same reference numerals are given to the procedures equivalent to those in FIGS. 6 and 7, and the description will be omitted.

In FIG. 13, in this variation, similarly to the variation in the above (2), at Step S175, if there is the unregistered management item and the determination is satisfied at Step S170, the control circuit 115 determines if the unregistered management item is a predetermined unregistered management item or not. Particularly, in this variation, the control circuit 115 determines if the item is the predetermined unregistered management item or not on the basis of related information stored in the database in advance in association with the management item.

For example, in this variation, time and date information, not shown, when the management item was registered is stored in the database 131 in advance as related information. In this case, at Step S175, the time and date information when the management item was registered in the database 131 is compared with the current time and date information obtained from the clock part 180 for the unregistered management item. Also, a predetermined time to be a determination reference on whether or not the predetermined unregistered management item is applicable is set in advance in relation with time from the time and date of registration of the management item in the database 131 to the current time. If the time from the time and date when the management item is registered in the database 131 to the current time is less than the predetermined time, it is determined at Step S175 that the item is the predetermined unregistered management item, and the routine goes on to processing at Step S180. On the other hand, if the time from the time and date of registration of the management item in the database 131 to the current time is the predetermined time or more, it is determined at Step S175 that the item is not the predetermined unregistered management item, and the routine returns to Step S110 in FIG. 6.

For example, even if there is an unregistered management item in the management items associated with the acquired tag ID, when considerable days have passed since the management items were set till the tag ID is acquired, it is highly likely that the management data corresponding to the management item does not have to be entered. According to this variation, in such a case, it can be set such that the unregistered management item is not displayed on the display part, and convenience in operation can be improved.

Information stored in the database in advance as the related information is not limited to the above examples. For example, a predetermined keyword of an article name and a management item to be managed for the keyword may be set in the database as the related information in order to determine if the item is a predetermined management item to be managed or not for each article. In this case, the associated article name registered in the database 131 is referred to for each acquired tag ID. If the predetermined keyword is included in the article name, it is determined if the predetermined management item determined corresponding to the keyword is unregistered or not. Other than the above, the related information may include priorities of the management items to be managed for each article so that the predetermined management item is extracted in the order from the higher priority and determination is made if the predetermined management item is an unregistered management item or not. In the variations in the above (2) and (3), every time a single tag ID is acquired, it is determined if the predetermined management item is an unregistered management item or not even in the middle of the ID acquisition command. However, not limited to that, as in the variation in the above (1), it may be so configured that once a single session of the ID acquisition command is completed, determination is made on whether or not the predetermined management item is unregistered or not for the acquired plural or single tag ID at the same time.

According to this variation, it is possible to easily set predetermined management items according to a situation such as a case in which the management item for which registration information should be registered is changed according to an operation, a case in which the management items to be managed are different according to an article, and a case in which the management item for which registration information should be registered for each article is added and updated. As a result, an unregistered management item for the predetermined management item can be reliably grasped for each article according to an operation state. As a result, it is no longer necessary to separately search or examine for which management item and for which article the management data is not registered, for example.

(4) When image data is registered as management data:

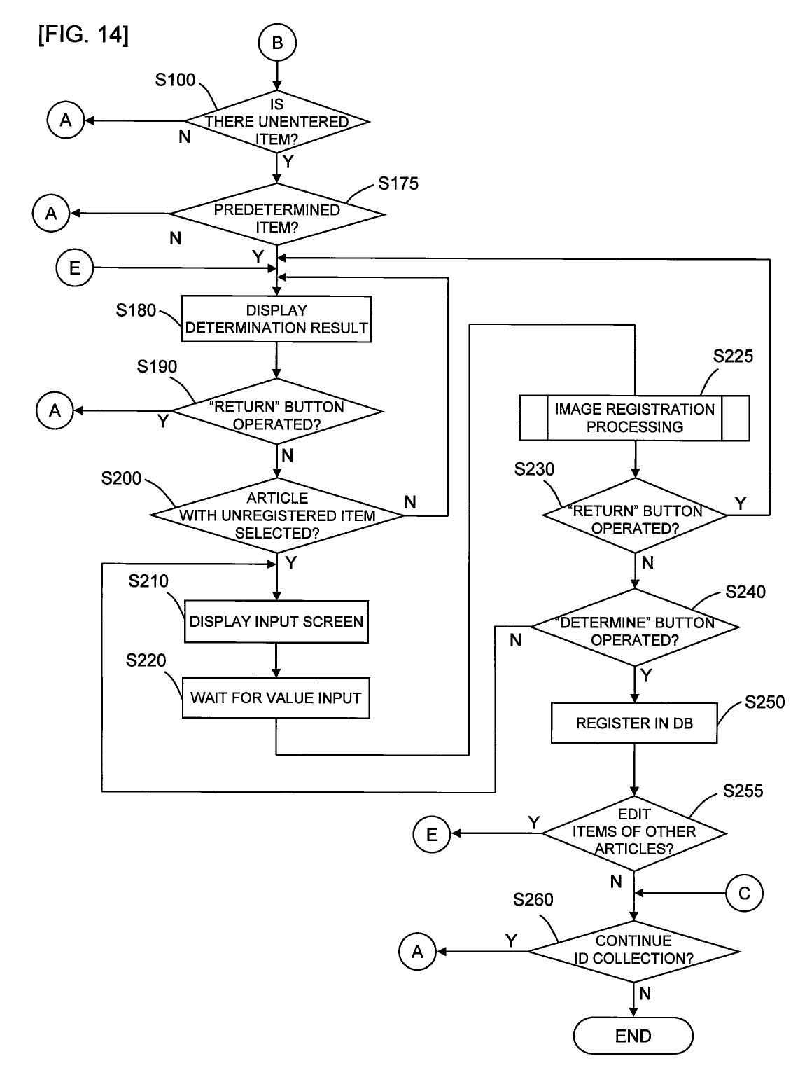

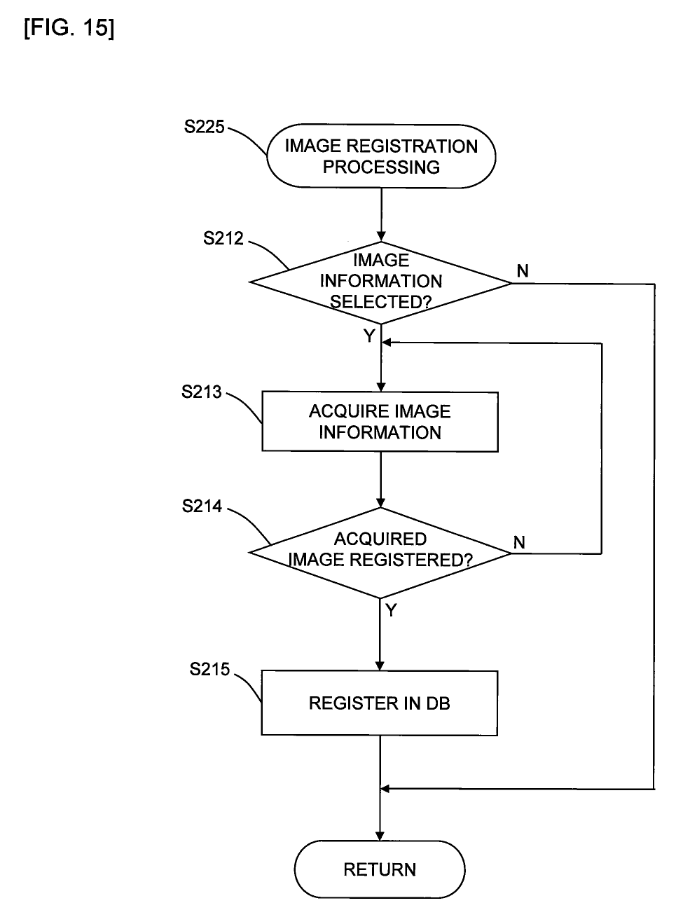

This variation will be described using FIGS. 14 and 15. FIG. 14 corresponds to FIG. 7, and image registration processing at Step S225, whose details will be described in FIG. 15, is provided subsequent to Step S220. Since the other parts of processing are equivalent to those procedures in FIGS. 6 and 7, the description will be omitted.

In this variation, the routine stands by till the operation input is made at Step S220 in FIG. 14, and then, the routine goes to the newly provided Step S225.

As shown in FIG. 15, Step S225 includes Step S212, Step S213, Step S214, and Step S215 in detail. At Step S212, the control circuit 115 determines if image information of an actual article has been selected or not as input information to be registered in the unregistered management item, that is, as management data. Though not shown, if an image selection tab is displayed on the screen and the operator operates the image selection button using the operation input part 120 or the operation input key 122, for example, it is determined that the image information has been selected as input information, and the routine goes to Step S213. On the other hand, if the image information has not been selected, the routine in FIG. 15 is finished, and the routine goes to Step S230 in FIG. 14.

Subsequently, at Step S213, the control circuit 115 acquires the image information taken by the camera 200 disposed in the apparatus 100. Then, the routine goes to Step S214.

At Step S214, the control circuit 115 determines whether or not to input the image information acquired at Step S213 as input information in the management item. That is, though not shown, on the display part 111, for example, the image information acquired by the camera 200 and a registration determination tab are displayed as a display image. Then, if the operator performs an operation of registration determination using the operation input part 120 or the operation input key 122, the determination at Step S214 is satisfied, it is considered that the acquired image information is determined to be registered as the input information, and the routine goes to Step S215. On the other hand, if the operator operates the “return” key, the determination at Step S214 is not satisfied, it is considered that the image information is not to be registered as the input information, and the routine returns to Step S213.

At Step S215, the control circuit 115 registers the image information acquired by imaging in the database 131 as management data. Then, this routine is finished, and the routine goes to Step S230 in FIG. 14.

In this variation, the camera 200 constitutes an imaging device that can image a target article to which the RFID label T is affixed. In this variation, when the apparatus 100 reads a tag ID, its management state such as appearance, arrangement, for example, of the article is imaged by the camera, and the taken image can be registered in the database as image information on the spot. Also, the image information relating to the article can be checked any time by accessing the database as necessary. As a result, convenience in asset management is extremely high.

(5) When the database is located in a server:

In the above, the case in which the database 131 is located in the RAM 130 in the apparatus 100 has been described, but not limited to that. That is, the database 131 may be located in a server which is connected through the external connection circuit 140 of the apparatus 100 via wireless LAN, for example. In this case, in the above, at Step S250 in FIGS. 7, 13 and 14 and at Step S215 in FIG. 15, the control circuit 115 outputs management data to be registered in the database to the server through the external connection circuit 140. By thus managing the database in the server, even if inventory taking is carried out using a plurality of apparatuses for communicating with an RFID tag, update and registration in the database can be efficiently carried out any time. In this variation, Step S250 and Step S215 executed by the control circuit 115 constitute a management data output portion configured to output registration information for registration of the management data entered by the input device in the database 131. Other than the above, the database may be stored in a memory used by being inserted and attached to the apparatus for communicating with an RFID tag.

In addition, setting of whether or not the unregistered management item is displayed on the display part and setting of on or off of a function to display the determination result may be configured to be made simultaneously by an operation of the operation input part 120 by the operator. Also, when the determination result is displayed on the display part 110 in the apparatus 100, an alarm may be given by warning sound by the sound production device 160 or vibration by the vibration device 170 at the same time. Also, other than the description above, the embodiments and methods in the variations may be used in combination as appropriate, and though not exemplified, the present invention is put into practice with various changes in a range not departing from its gist.

What is claimed is:

1. An apparatus for communicating with a radio frequency identification (RFID) tag comprising:
an apparatus antenna device configured to conduct radio communication with an RFID tag circuit element, said RFID tag circuit element being disposed in an RFID label and having an IC circuit part capable of storing information and a tag antenna capable of transmission and reception of information;
a tag information obtainment portion configured to obtain identification information from said RFID tag circuit element via said apparatus antenna device;
a management item determination portion configured to determine, when said tag information obtainment portion obtains said identification information, whether or not there is an unregistered management item for which management data is not registered in a database configured to store the obtained identification information and management data for a management item of a target article to which said RFID label is affixed in association with each other; and
an unregistered information display device configured to display, when said management item determination portion determines that there is an unregistered management item, information relating to said unregistered management item.

2. The apparatus according to claim 1, further comprising
an unregistered management item determination portion configured to determine, when said management item determination portion determines that there is an unregistered management item, whether or not said unregistered management item is a predetermined management item for which the management data should be registered, wherein
said unregistered information display device displays information relating to said unregistered management item if said unregistered management item determination portion determines that the unregistered management item is the predetermined management item.

3. The apparatus according to claim 2, wherein:
said unregistered management item determination portion determines whether or not said unregistered management item is said predetermined management item, said unregistered management item determination portion determining by unit of each identification information on the basis of related information, said identification information obtained by said tag information obtainment portion, said related information being stored in the database in advance in association with said management item.

4. The apparatus according to claim 1, wherein:
when said tag information obtainment portion obtains a plurality of identification information, said unregistered information display device displays information in a list, the information relating to unregistered management items corresponding to the plurality of identification information obtained by said tag information obtainment portion.

5. The apparatus according to claim 1, further comprising:
an input device capable of entering management data for said unregistered management item; and
a management data registration portion configured to register said management data entered by said input device in said database, wherein
said unregistered information display device displays said management data so that said management data related to said unregistered management item is capable of being entered by said input device.

6. The apparatus according to claim 1, further comprising:
an input device capable of inputting management data for said unregistered management item; and
a management data output portion configured to output registration information for registering said management data entered by said input device in said database, wherein
said unregistered information display device displays said management data so that said management data related to said unregistered management item is capable of being entered by said input device.

7. The apparatus according to claim 5, further comprising
an imaging device capable of imaging a target article to which said RFID label is affixed, wherein
said input device enters image data taken by said imaging device as said management data.
